(19) United States
(12) Patent Application Publication
(10) Pub. No.: US 2010/0206026 A1
(43) Pub. Date: Aug. 19, 2010

(54) PROFILE KEY WITH LOCAL RECESS

(76) Inventor: Bo Widen, Torshilla (SE)

Correspondence Address: BIRCH STEWART KOLASCH & BIRCH, PO BOX 747, FALLS CHURCH, VA, 22040-0747, US

(21) Appl. No.: 12/388,027

(22) Filed: Feb. 18, 2009

(51) Int. Cl. E05B 29/02

(52) U.S. Cl. 70/358

(57) ABSTRACT

A profiled key for use in an associated cylinder lock provided with a rotatable key plug having a longitudinal keyway. The key has a substantially flat key blade with a longitudinally extending profile groove at a side surface thereof and at least one local recess adjacent to said profile groove. The local recess constitutes a locally expanded portion of said profile groove, and the locally expanded portion of the profile groove has a cross-section with two opposite, non-symmetrical side walls. The local reces will accommodate a blocking element in the lock, and permit full insertion of the key blade into the keyway.

### FIELD AND BACKGROUND OF THE INVENTION

The present invention relates to a key for use in an associated cylinder provided with a rotatable key plug having a longitudinial keyway. The key blade has a substantially flat key blade and a longitudinally extending profile groove. The key is especially adapted for use in a lock having a blocking element, which is movable elevationally so as to prevent the insertion of an incorrectly cut key blade into the keyway.

The key of the present invention is part of an inventive concept of a lock and key combination, which is the subject of a separate patent application being filed in parallel with the present application.

The contents of the parallel application mentioned above is incorporated in this disclosure by refernce.

Similar lock and key combinations are generally known, e.g. from the U.S. Pat. No. 5,715,717 (Widén). The profile groove or grooves in the key will provide great possibilities to vary the cross-sectional profile of the key, which is a great advantage.

### OBJECT OF THE INVENTION

The object of the present invention is to provide a key, cooperating with a blocking mechanism in the lock and providing an increased number of profile varieties.

### SUMMARY OF THE INVENTION

According to the present invention, this object is achieved by providing a key having a substantially flat key blade and being characterized in that said substantially flat key blade has a longitudinally extending profile groove at at least one side surface thereof, said profile groove is provided with an inner, longitudinally straight portion corresponding to the outermost portion of a profile rib in said longitudinal key way of the key plug, said substantially flat key blade also has at least one local recess adjacent to said profile groove, said at least one local recess constitutes a locally expanded portion of said profile groove, and said locally expanded portion of the profile groove has a cross-section with two opposite, non-symmetrical side walls.

As will be explained below, the locally expanded portion of the profile groove will accomodate a blocking element arranged in the associated lock, upon moving the blocking element from an initial position to a second position enabling full insertion of the key blade into the lock. In case a differently cut key blade is inserted, i.e. a key blade without a local recess adjacent to the profile groove, the blocking element of the lock will stop the key blade from being fully inserted into the keyway.

The key may be configured in various ways, in accordance with the dependent claims and as explained further below with reference to the appended drawings.

### SHORT DESCRIPTION OF THE DRAWINGS

FIG. 1a shows, in a side view, a cylinder lock, with a key blade inserted therein;

FIG. 1b shows the cylinder lock and key combination of FIG. 1a in a perspective view;

FIG. 1c shows the lock and key combination of FIG. 1a in a perspective, exploded view, illustrating a locking mechanism above the keyway of the lock and the key blade according to the invention;

FIG. 1d shows a cross-section along the line Id-Id in FIG. 1a also illustrating a blocking element arranged in the key plug of the lock;

FIG. 1e shows a cross-section as in FIG. 1d, but without a key;

FIG. 1f shows a cross-section along the line 1f-1f in FIG. 1a;

FIGS. 2a, 2k show schematically in perspective views how the key blade interacts with the blocking element of the lock (FIG. 2b at a larger scale);

FIGS. 3a and 3b show the key blade of FIGS. 2a, 2b in a side view (FIG. 2b at a larger scale);

FIG. 4 shows, in a side view, a key blade anid a blocking element located closer to the entrance of the keyway;

FIGS. 5 and 6 show the blocking element and the key blade of FIG. 4 in a cross-sectional view and an end view, respectively.

### DETAILED DESCRIPTION OF PREFERRED EMBODIMENTS

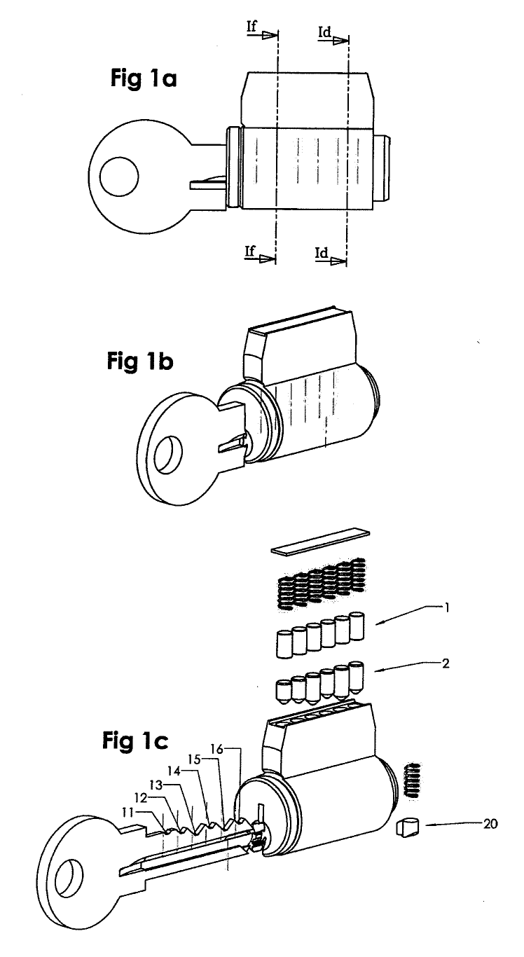

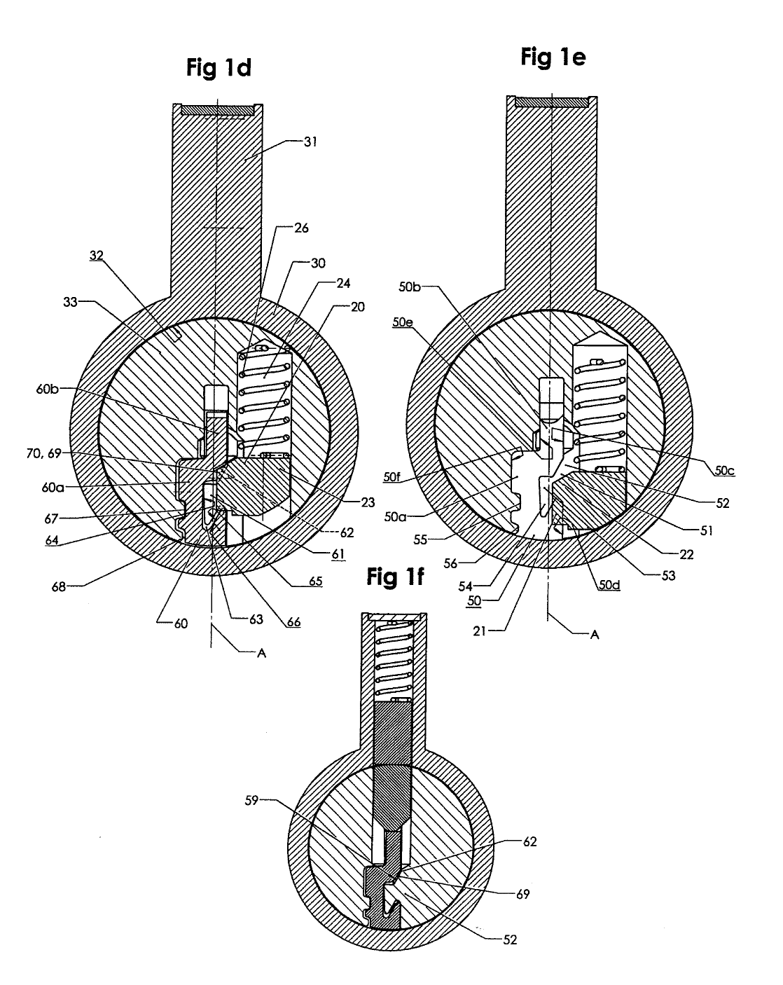

In FIGS. 1a, 1b, 1c, 1d, 1e, 1f there is shown a cylinder lock and key combination having conventional upper and lower tumbler pins 1, 2 in a linear row (FIG. 1c) cooperating with an upper edge of the inserted key blade, the upper edge having a corresponding numiber of recess cuts 11, 12, 13, 14, 15, 16 at various levels. Deep inside the keyway of the lock, not very far from the tip of the inserted key blade, there is a blocking element 20, which is movable elevationally (up and down) at the side of the keyway.

The blocking element, and its interaction with the inserted key blade, will be better understood from FIG. 1d. Here, the cylindrical housing of the lock is denoted 30, having an upright housing part 31 accomodating the upper locking pins 1, 2 mentioned above and a cylindrical bore 32, in which a cylindrical key plug 33 is rotatably journalled.

The key plug 33 has a central keyway 34 extending lonigitudinally along the axis of the cylindrical bore 32 and a central plane A extending through the cylindrical axis and the upper housing portion 31. In a longitudinal row in this plane A, there are a number of cylindrical holes (not visible in FIG. 1d) each accotmmodating one of the lower locking pins 2. In FIGS. 1d and 1e, the profile of the keyway 50 and the corresponding key blade 60 are clearly visible. The keyway 50 is oriented along the central plane A. It has a lower, rather wide portion 50a, and an upper, relatively narrow portion 50b. The upper and lower portions of the keyway have side walls 50c and 50d lying in a common plane in parallel to the central plane A (to the right thereof in FIG. 3). At the other lateral side, the upper keyway portion 50b has a side wall 50e, whereas the lower part of the keyway has a side wall 50f, the latter being located further away from the central plane A than the upper side wall 50e.

On the right hand side of the keyway, there is a longitudinal, profiled rib 51 extending along the key plug. The profile rib 51 has a base portion 52 (concealed by the blocking element 20 in FIG. 1d) and an end portion 53 provided with a downwardly directed tongue 54.

On the left hand side, the keyway has two longitudinal ribs 55 and 56 at the lower portiion of the keyway.

The key blade 60 (see FIG. 1d), according to the present invention, has a profile shape which is substantially supplementary to the keyway 50. Accordingly, the key 60 has a lower base portion 60a, which is relatively wide, and an upper portion 60b, which is relatively narrow.

At the right hand side (as seen in FIG. 1d) the key blade has a longitudinally extending groove 61 with an outer portion 62, and an inner, undercut portion 63. The profile groove 60 has a bottom wall 64 and an opposite side wall 65, which is inclined and faces the bottom wall 64 and also forms the inside wall of a ridge 66 extending along the key blade 60.

As will be evident from FIG. 1d, the profile groove 61 accomodates the longitudinally extending profile rib 51, including the downwardly directed tongue 54 in the undercut portion of the groove 61.

On the left hand side, the key blade 60 has two longitudinal grooves 67 and 68 corresponding to the profile ribs 55, 54.

As appears from FIG. 1f, the outer portion 62 of the profile groove 61, and the corresponding base portion 52 of the profile rib 50 has a slanted upper wall 69 and slanted surface 59, respectively.

Now, since the sectional profile of the key blade 60 corresponds to the cross-sectional profile of the keyway 50, the key blade 60 can be inserted partially or fully into the keyway, as is known in the art. Of course, only key blades being cut with the particular profile of the keyway may be fully inserted into the keyway.

In order to allow for further variations of the exact profile of the keyway, there is provided, according to the present invention, a blocking element 20 (as mentioned above) which can be regarded as a movable profile portion.

Generally, the blocking elemeut has a profile section, which corresponds to the longitudinally extending groove 61 in the key blade. However, in the region of the outer portion 62 of the groove 61, it is somewhat larger, in a direction parallel to the central plane A. So, it does not fit into the profile groove of the keyway along the full length thereof.

However, according to the present invention, the key blade 60 is provided with a local recess 70 which constitutes a locally expanded portion of the profile groove 62 and is wide enough to accomfliiiodate the uppermost portion of the blocking element 20, as will be explained more fully below.

In order to secure a well-defined mobility of the blocking elemnent 20, it is integrated with or firmly connected to a body 23, which is guided for elevational movement in parallel to the central plane A of the key way in a substantially cylindrical cavity 24 at the side of the keyway, in parallel to the central plane A. Thus, the body 23 is guided for movement up and down in the cylindrical cavity 24, so that the integrated or connected blocking element 20 is also movable up and down.

The blocking element 20 may protrude partially or fully into the profile groove 61, in a cut-out portion of the profile rib 51.

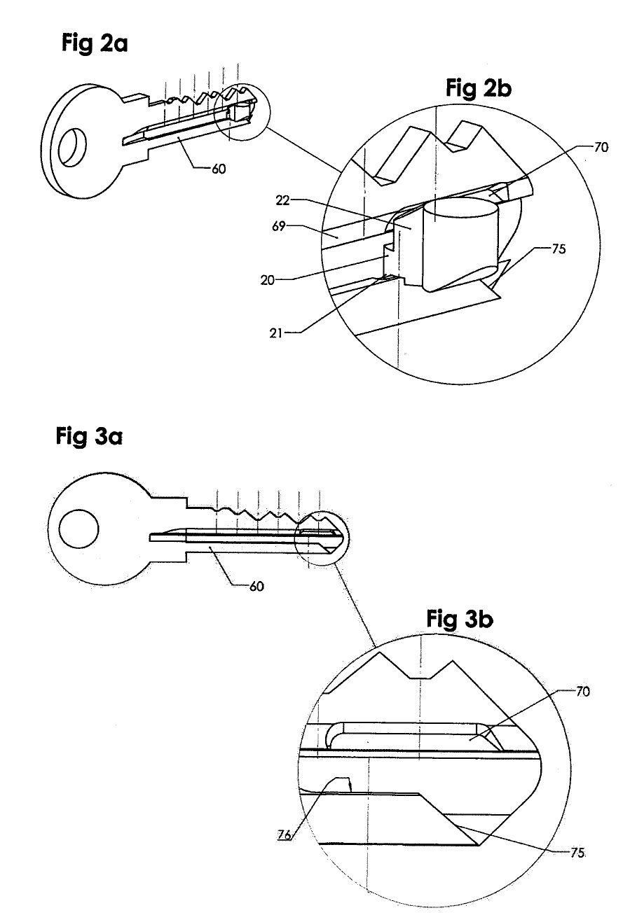

The interaction between the blockling element and the key blade is illustrated in FIGS. 2a, 2b, 3a, 3b. Initially, when the keyway 50 is empty (see FIG. 1e), the blocking element 20 will be positioned in its lowermost position, because of the action of a compression spring 26 in the cavity 24 (FIG. 1d). In the embodiment of FIGS. 2a, 2b, 2a, 2b, the profile groove 61 of the key blade 60 has no undercut portion, but this will not make any difference to the interaction between the key blade and the blocking element 20.

When the key blade 60 is inserted into the keyway 50, a lower, first portion 21 of the blocking elemeent 20 will make contact with a ramp surface 75 near the tip end of the key blade. By way of this contact, the blocking element 20 will move upwards and take the position shown in FIGS. 1d and 7b. Here, the upper, second portion 22 of the blocking element 20 will be accommodated in the above-mentioned recess 70, which is locally cut out in this particular part of the keyway, so the width of the profile groove is effectively widened in this region.

Without such a recess 70, the blocking element would be jammed between the ramp surface 75 and the upper, slanted wall 69 of the longitudinal profile groove.

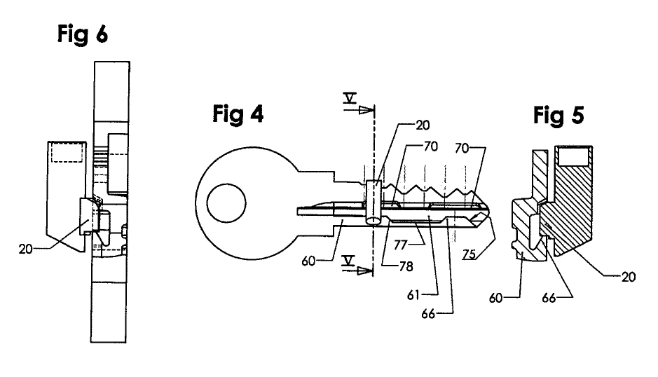

In the embodiment shown in FIGS. 2a and 2b, the blocking pin 20 is located deep inside the keyway near the tip end of the key blade upon full insertion of the key blade into the keyway. The first or lower projecting portion 21 of the blocking elemnent 20 contacts a machined, slightly recessed surface 76 (FIG. 3b) adjacent to the lower side wall of the profile groove (in this embodinment there is no undercut portion), whereas the upper or second projecting portion 22 of the blocking element 20 is accomnmodated in the local recess 70. This recess 70 is confined to the region of the fully inserted key blade in the vicinity of the blocking element 20. In FIGS. 4, 5, 6, the blocking element 20 is located closer to the entrance of the keyway, so when the key blade is fully inserted into the keyway, the blocking element 20 is far away from the tip end of key blade. In order to accomlmodate the whole cross-section of the blocking element 20, the lower part of the key blade material next to the groove 61 is taken away. Thus, the ridge portion 66 is cut away from the tip end of the key blade up to the location of the blocking element, leaving a lower side wall 77, except for a portion near the tip end of the key blade. In this case, of course, the local upper recess, accommodating the second or upper projecting portion 22 of the blocking elenment 20 is located so as to start, with some overlap, where the lower side wall 77 and an adjoining inclined or ramp surface 78 ends. The overlap length should correspond or slightly exceed the dimension of the blocking element 20 in the longitudinal direction of the key plug.

The upper, slanted wall portion of the recess 70 has an angle corresponding to the second projecting portion 22 of the blocking element 20.

As will be seen from FIG. 4, the key blade is provided with a second local recess 70 near the tip end, just like the key blade shown in FIGS. 8a and 8b. Therefore, the key blade of FIG. 10 will cooperate also with a blocking element 20 arranged deep inside the keyway, like the one shown in FIG. 2b.

Accordingly, by havinig two or more blocking elements distributed longitudinally along the keyway, it is possible to provide a hierarchic system with master keys that open all individual locks having blocking pins at various locations.

The blocking element in the lock may be urged to move up and down only by interaction with the profile groove and its adjoining recesses above and below the groove, without any spring acting on the body in the side cavity. Thus, the blocking element will then be positively guided by the upper and lower side walls of the partially expanded profile groove.

1. A key for use in an associated cylinder lock provided with a rotatable key plug having a longitudinal key way, said key having a substantially flat key blade (60) and being characterised in that
said substantially flat key blade has a longitudinally extending profile groove (61) at at least one side surface thereof, -said profile groove is provided with an inner, longitudinally straight portion corresponding to the outermost portion of a profile rib in said longitudinal key way of the key plug,
said substantially flat key blade also has at least one local recess (70) adjacent to said profile groove,
said at least one local recess constitutes a locally expanded portion of said profile groove, and
said locally expanded portion of the profile groove has a crosss-section with two opposite, non-symmetrical side walls (69, 63).

2. A key as defined in claim 1, wherein said inner, straight portion of said profile groove of the key blade extends along at least a part of said key blade, whereas said adjoining local recess is limited to a longitudinally confined portion of the key blade being shorter than said niajor part.

3. A key as defined in claim 1, wherein said inner, straight portion of said profile groove of the key blade has a substantially rectangular cross-section.

4. A key as defined in claim 1, wherein said inner, straight portion of said profile groove of the key blade has an undercut part.

5. A key as defined in claim 2, wherein said profile groove in the side surface of said key blade has an outer, longituidinally straight portion extending along at least a part of the length of said inner, straight portion and merging with the latter, said outer, longitudinally straight portion of the groove having an upper wall being slanted and facing away from the key blade.

6. A key as defined in claim 5, wherein said locally expanded portion of the profile groove has a first or lower wall portion, oriented substantially perpendicularly to said side surface of the key blade, and a second or upper, slanted wall portion being inclined so as to face outwardly from the associated side of the key blade.

7. A key as defined in claim 1, wherein said locally expanded portion of the profile groove has a longitudinally adjoining opposite recess at the opposite side wall of the profile groove, said longitudially adjoining opposite recess being located opposite to said local recess and, in the longitudinal direction, closer to the tip end of the key blade.

8. A key as defined in claim 7, wherein said longitudinally adjoining recess is constituted by a ramp surface leading from the bottom edge of the key blade into said profile groove.

9. A key as defined in claim 7, wherein said longitudinally adjoining opposite recess is a recess in said opposite side wall and has a longitudinally straight surface extending in parallel to said profile groove.

10. A key as defined in claim 7, wherein the key blade has at least two locally expanded profile groove portions, and an adjoining opposite recess between each pair of such locally expanded profile groove portions.

11. A key as defined in claim 7, wherein there is a longitudinal overlap between said locally expanded profile groove portion and said longidtuinally adjoining opposite recess.
